(19) United States
(12) Patent Application Publication
(10) Pub. No.: US 2009/0049913 A1
(43) Pub. Date: Feb. 26, 2009

(54) METHOD OF BEAT TUNING IN A SLIGHTLY ASYMMETRIC RING-TYPE STRUCTURE

(75) Inventors: Yeon June Kang, Seoul (KR); Han Gil Park, Seoul (KR); Seock Hyun Kim, Gangwon-do (KR); Jang Moo Lee, Seoul (KR)

Correspondence Address: PEARNE & GORDON LLP, 1801 EAST 9TH STREET, SUITE 1200, CLEVELAND, OH, 44114-3108, US

(73) Assignee: SEOUL NATIONAL UNIVERSITY INDUSTRY FOUNDATION, Seoul (KR)

(21) Appl. No.: 11/851,730

(22) Filed: Sep. 7, 2007

(30) Foreign Application Priority Data
Aug. 20, 2007 (KR) 1020070083576

(51) Int. Cl. G01H 1/06

(52) U.S. Cl. 73/580

(57) ABSTRACT

The present disclosure relates to a method of beat tuning in a slightly asymmetric ring-type structure, and can be effectively used to control the beat property of a structure such as a bell, which can be modeled to a slightly asymmetric ring.

A method of beat tuning in a slightly asymmetric ring structure includes the steps of establishing an original ring model which simplifies said ring structure, establishing an equivalent imperfection mass model which is equivalent to said original ring model and has at least one or more point masses on an asymmetric ring, determining magnitudes and positions of the point masses in said equivalent imperfection mass model based on mode data of said original ring model, and determining magnitudes and positions of masses which should be added to or removed from said equivalent imperfection mass model in order to obtain desired beat properties.

### TECHNICAL FIELD

The present disclosure relates to a method of beat tuning in a slightly asymmetric ring-type structure, and more particularly, to a method of controlling the beat property of a structure such as bell, which can be modeled to a slightly asymmetric ring.

### BACKGROUND

Korean bells have been fabricated since the time of the ancient Silla dynasty (57 B.C.˜935 A.D.). They have a unique shape and an exquisite appearance and they produce beautiful sounds. Recently, many researches have been carried out to reconstruct beauty of Korean bells by scientifically designing and manufacturing them.

The natural frequencies of bell vibration modes are essentially determined by the main dimensions of the nearly axisymmetric body and the material properties of the bell. Sculptures and figures carved on the bell body and casting irregularities induce a slight asymmetry, and the bell consequently generates beating sounds.

The strong beat of a western bell is called a warble and is often considered an undesirable property. In fact, western bell makers try to eliminate this phenomenon or at least maintain it within reasonable limits. In Korean bells, however, the intervals between strikings are quite long and therefore, people hear different sounds from the long-lasting beat of the hum, the fundamental, and the striking sound. The hum and fundamental created by the 1^{st} and the 2^{nd} vibration modes last much longer than the other higher partials. When the hum has a clear beat with an appropriate period, people hear a lively bell sound, as if the bell were alive and breathing. In most Korean bells, the 1^{st} and the 2^{nd} vibration modes do not exhibit any phase change along the vertical axis heights. Therefore, a ring-type structure may be applied as a simplified model for the analysis of the frequency and beat characteristics of low-order vibration modes like the 1^{st} and the 2^{nd} vibration modes in these bells.

Many researches have been carried out on a ring-type structure with slight asymmetry. Charnley and Perrin investigated the mode splitting of an eccentric ring and examined the warble in a bell with slight asymmetry [T. Charnley and R. Perrin, 1978, Studies with eccentric bell, Journal of Sound and Vibration 58, 517-525; R. Perrin and T. Charnley and H. Bandu, 1982, Increasing the lifetime of warble-suppressed bells, Journal of Sound and Vibration 80, 298-303; R. Perrin, T. Charnley, G. M. Swallowe, 1995, On the tuning of church and carillon bells, Applied Acoustics 46, 83-101]. Allei and Soedel applied the receptance method to calculate the natural frequencies of a circular ring with local masses and springs [D. Allaei, W. Soedel and T. Y. Yang, 1988, Vibration analysis of non-axisymmetric tires, Journal of Sound and Vibration 122, 11˜29]. Hong and Lee obtained a precise solution for an asymmetric circular ring by considering the local mass and stiffness deviations as a Heaviside step function [J. S. Hong, J. M. Lee, 1994, Vibration of circular rings with local deviation, Journal of Applied Mechanics 61, 317-322]. Using the Rayleigh-Ritz method, Fox proposed a theoretical model to calculate the modal parameter s of a circular ring with multiple point masses [C. H. J. Fox, 1990, A simple theory for the analysis and correction of frequency splitting in slightly imperfect rings, Journal of Sound and Vibration 142(2), 227-243]. He and his colleagues showed that the model could be applied to trim N pairs of modes simultaneously by removing N trimming masses at particular locations around the ring [A. K. Rourke, S. McWilliam, C. H. J. Fox, 2001, Multi-mode trimming of imperfect rings, Journal of Sound and Vibration 248(4), 695-724]. Using impulse response analysis, Kim et al. performed a detailed investigation of the beat distribution characteristics on the circumference of bell-type structures [S. H. Kim, W. Soedel, J. M. Lee, 1994, Analysis of the beating response of bell type structures, Journal of Sound and Vibration 173(4), 517-536; S. H. Kim, C. W. Lee, J. M. Lee, 2005, Beat characteristics and beat maps of the King Seong-deok Divine Bell, Journal of Sound and Vibration 281, 21-44].

The established researches like these have been mainly performed with a view to examine the characteristics of vibration and sounds for the fabricated bell and to eliminate frequency splitting on a ring-type structure with slight asymmetry. Thus, there is a need for a method to predict and to control the required beat conditions from the design stage in order to reproduce Korean bell.

However, it is very difficult to fabricate a bell as predicted with the present casting skill since the beat properties are created by the slight asymmetry generated in fabricating the bell. Therefore, a tuning method to improve beat properties is alternatively used by cutting necessary amounts for the appropriate locations of the fabricated bell.

### SUMMARY

The present disclosure provides a new method to create the required beat conditions, which are relatively accurate, by using the model of Fox's equivalent imperfection masses, although Fox and his colleagues proposed this model with a view to eliminate frequency splitting.

The present disclosure relates to a method of beat tuning in a slightly asymmetric ring-type structure. The method in accordance with one embodiment of the present disclosure includes the steps of establishing an original ring model which simplifies said ring structure, establishing an equivalent imperfection mass model which is equivalent to said original ring model and has at least one or more point masses on an asymmetric ring, determining magnitudes and positions of the point masses in said equivalent imperfection mass model based on mode data of said original ring model, and determining magnitudes and positions of masses which should be added to or removed from said equivalent imperfection mass model in order to obtain desired beat properties.

In one embodiment, a method of beat tuning in a slightly asymmetric ring-type structure illustrates the mode data of said original ring model as the natural frequencies and the locations of the low mode anti-node. It is because that the beat period becomes a frequency difference of a high and low (L-H) mode pair and the clarity is determined by the located interval of the nodal line in a high and low (L-H) mode pair.

In another embodiment, a method of beat tuning in a slightly asymmetric ring-type structure is preferred in n=2 mode and/or n=3 mode. The reason is because the vibration of n=2 and n=3 modes in Korean bell lasts longest and thus the beat properties of the two modes are most important.

In yet another embodiment, a method of beat tuning in a slightly asymmetric ring-type structure finally determines magnitudes (m_{c}, m_{d}) and positions (φ_{c}, φ_{d}) of masses which should be added or removed for beat tuning. In order to satisfy desired beat properties, magnitudes and positions of masses which should be added or removed are determined by using the mode data, which are measured from the experiment, such as the natural frequencies and the locations of low mode anti-node for the manufactured bell and the following equation:

$$\begin{matrix}\begin{matrix}[ \begin{matrix}cos 4 ( {φ}_{c} - {ψ}_{2}^{*} ) & cos 4 ( {φ}_{d} - {ψ}_{2}^{*} ) \\ cos 6 ( {φ}_{c} - {ψ}_{3}^{*} ) & cos 6 ( {φ}_{d} - {ψ}_{3}^{*} )\end{matrix} ] \\ {[ \begin{matrix}sin 4 ( {φ}_{c} - {ψ}_{2}^{*} ) & sin 4 ( {φ}_{d} - {ψ}_{2}^{*} ) \\ sin 6 ( {φ}_{d} - {ψ}_{3}^{*} ) & sin 6 ( {φ}_{d} - {ψ}_{3}^{*} )\end{matrix} ]}^{- 1}\end{matrix} \\ [ \begin{matrix}- {m}_{a} sin 4 ( {φ}_{a} - {ψ}_{2}^{*} ) - {m}_{b} sin 4 ( {φ}_{b} - {ψ}_{2}^{*} ) \\ - {m}_{a} sin 6 ( {φ}_{a} - {ψ}_{3}^{*} ) - {m}_{b} sin 6 ( {φ}_{b} - {ψ}_{3}^{*} )\end{matrix} ]\end{matrix} = [ \begin{matrix}\begin{matrix}- {m}_{a} cos 4 ( {φ}_{a} - {ψ}_{2}^{*} ) - \\ {m}_{b} cos 4 ( {φ}_{b} - {ψ}_{2}^{*} ) + M \frac{1}{{k}_{2}} {λ}_{2}\end{matrix} \\ \begin{matrix}- {m}_{a} cos 6 ( {φ}_{a} - {ψ}_{3}^{*} ) - \\ {m}_{b} cos 6 ( {φ}_{b} - {ψ}_{3}^{*} ) + M \frac{1}{{k}_{3}} {λ}_{3}\end{matrix}\end{matrix} ]$$

In a further embodiment, a method of beat tuning in a slightly asymmetric ring-type structure is achieved by considering a mass effect and a stiffness effect.

### BRIEF DESCRIPTION OF THE DRAWINGS

The disclosure may best be understood by reference to the following description taken in conjunction with the following figures:

FIG. 1 illustrates the concept of dual mode equivalent ring model in accordance with one embodiment of the present disclosure;

FIG. 2 shows positions of additional imperfection masses in dual mode equivalent ring model in accordance with one embodiment of the present disclosure;

FIG. 3 illustrates original ring and equivalent ring models in accordance with one embodiment of the present disclosure;

FIG. 4 shows positions of two additional imperfection masses for tuning in accordance with one embodiment of the present disclosure; and

FIG. 5 shows beat period and location of low mode anti-node after tuning in accordance with one embodiment of the present disclosure.

### DETAILED DESCRIPTION

In the following description, numerous specific details are set forth. It will be apparent, however, that these embodiments may be practiced without some or all of these specific details. In other instances, well known process steps or elements have not been described in detail in order not to unnecessarily obscure the disclosure.

1. The Equivalent Imperfection Mass Model

Fox proposed an equivalent imperfection mass model that satisfies the mode splitting condition of a circular ring with multiple point masses. The present disclosure provides a method to obtain the appropriate period and a clear beat by using Fox's model. According to Fox's analysis results, the split natural frequency, ω_{L,H}, and the phase angle of the split mode, ψ_{L,H}, are determined by the following equations. Here, the subscript L or H indicates the split mode in the n-th mode that has a slightly lower or higher frequency, respectively.

$$\begin{matrix}tan 2 n {ψ}_{n} = \frac{{\sum }_{i} {m}_{i} sin 2 n {φ}_{i}}{{\sum }_{i} {m}_{i} cos 2 n {φ}_{i}} & 1 ) \\ {ω}_{nL , H}^{2} = {ω}_{0 n}^{2} ( \frac{1 + {α}_{n}^{2}}{( 1 + {α}_{n}^{2} ) + {\sum }_{i} {m}_{i} [ ( 1 + {α}_{n}^{2} ) ∓ ( 1 - {α}_{n}^{2} ) cos 2 n ( {φ}_{i} - {ψ}_{n} ) ] / {M}_{0}} ) & 2 )\end{matrix}$$

(n: mode number, mᵢ: i-th point mass, φᵢ: position of i-th point mass, ψₙ: anti-node of n-th L-mode, αₙ: ratio of radial displacement to tangential displacement, M₀: mass of perfect circular ring)

The present disclosure inversely uses an equivalent circular ring with n imperfection point masses that satisfy the mode condition signified by ω_{nL,nH} and ψₙ for beat tuning, while based on Fox's theoretical model. The mode condition for the analysis is obtained from modal experiments of a cast bell. The determining process for an equivalent slightly asymmetric ring is as follows. We can transform equations 1) and 2) into equations 3) and 4), respectively, by using standard trigonometric identities.

τmᵢ sin 2n(φᵢ−ψₙ)=0 3)

$$\sum {m}_{i} cos 2 n ( {φ}_{i} - {ψ}_{n} ) = M {λ}_{n} \\ {λ}_{n} = \frac{( {ω}_{nL}^{2} - {ω}_{nH}^{2} ) ( 1 + {α}_{n}^{2} )}{( {ω}_{nL}^{2} + {ω}_{nH}^{2} ) ( 1 - {α}_{n}^{2} )} , \\ M = {M}_{0} + \sum {m}_{i} \qquad 4 )$$

Based on equations 3) and 4), mᵢ and φᵢ that satisfy given ω_{nL,nH} and ψₙ can be inversely calculated. If we consider an equivalent model which satisfies only one mode condition, only an imperfection mass is required. If we consider an equivalent model which satisfies two mode conditions simultaneously, two imperfection masses are required.

If we consider the equivalent model with an imperfection mass which satisfies only one mode characteristic in n=2 mode or n=3 mode respectively, we can determine m_{eq} and φ_{eq}, which are the magnitude and position of an imperfection mass, respectively, from two constraints of equations 3) and 4). If we also consider the equivalent model with two imperfection masses which satisfies two mode conditions in n=2 mode and n=3 mode simultaneously, we can thus acquire four constraints that satisfy n=2 and n=3 mode conditions from equations 3) and 4). In this manner, the magnitude and position of two point masses-mₐ, m_{b}, φₐ, and φ_{b}—can be calculated. From this information, we can create a dual mode equivalent ring model that simultaneously satisfies the natural frequencies and locations of the anti-node for n=2 and n=3 modes.

2. Dual Mode Equivalent Ring Model

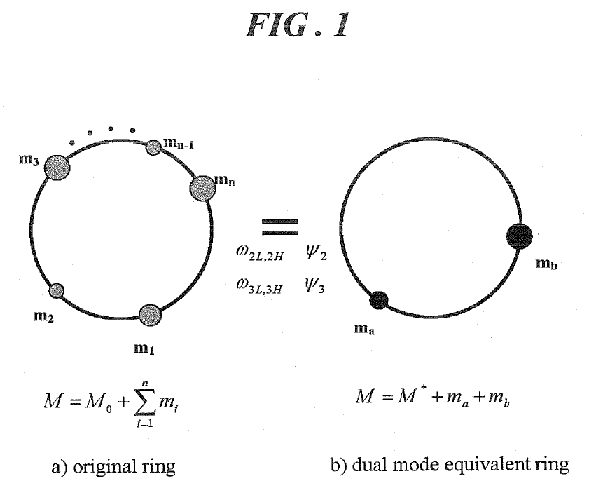

Let us now determine a dual mode equivalent ring model that satisfies the n=2 and n=3 mode pair conditions, as shown in FIG. 1 b). This equivalent model has two imperfection point masses that are not unique. FIG. 1 a) shows the original ring model with mode data ω_{2L,2H}, ω_{3L,3H}, ψ₂, and ψ₃. The original ring is a model which simplifies a real bell for tuning beat properties. In a real case, the original ring model is given not by the information on the magnitude and the position of imperfection masses but by mode data ω_{2L,2H}, ω_{3L,3H}, ψ₂, and ψ₃ obtained from experiments. The dual mode equivalent ring model satisfies the mode conditions that are exactly similar to those of the original ring model in the n=2 and n=3 modes. In other words, the below equations are completed from the condition that the dual mode equivalent ring model with two imperfection mass, mₐ and m_{b}, should have the same mode characteristics as the original ring model in n=2 mode and n=3 mode.

mₐ sin 4(φₐ−ψ₂)+m_{b} sin 4(φ_{b}−ψ₂)=0 5)

mₐ sin 6(φₐ−ψ₃)+m_{b} sin 6(φ_{b}−ψ₃)=0 6)

mₐ cos 4(φₐ−ψ₂)+m_{b} cos 4(φ_{b}−ψ₂)=Mλ₂ 7)

mₐ cos 6(φₐ−ψ₃)+m_{b} cos 6(φ_{b}−ψ₃)=Mλ₂ 8)

$$\begin{matrix}\text{Here} , & \\ {λ}_{2} = \frac{( {ω}_{2 L}^{2} - {ω}_{2 H}^{2} ) ( 1 + {α}_{2}^{2} )}{( {ω}_{2 L}^{2} + {ω}_{2 H}^{2} ) ( 1 - {α}_{2}^{2} )} , {λ}_{3} = \frac{( {ω}_{3 L}^{2} - {ω}_{3 H}^{2} ) ( 1 + {α}_{3}^{2} )}{( {ω}_{3 L}^{2} + {ω}_{3 H}^{2} ) ( 1 - {α}_{3}^{2} )} & 9 , 10 )\end{matrix}$$

Equations 5) and 6) can be transformed into a matrix form as shown below.

$$[ \begin{matrix}sin 4 ( {φ}_{a} - {ψ}_{2} ) & sin 4 ( {φ}_{b} - {ψ}_{2} ) \\ sin 6 ( {φ}_{a} - {ψ}_{3} ) & sin 6 ( {φ}_{b} - {ψ}_{3} )\end{matrix} ] [ \begin{matrix}{m}_{a} \\ {m}_{b}\end{matrix} ] = 0 \qquad 11 )$$

Likewise, equations 7) and 8) can be transformed into the following matrix form.

$$[ \begin{matrix}cos 4 ( {φ}_{a} - {ψ}_{2} ) & cos 4 ( {φ}_{b} - {ψ}_{2} ) \\ cos 6 ( {φ}_{a} - {ψ}_{3} ) & cos 6 ( {φ}_{b} - {ψ}_{3} )\end{matrix} ] [ \begin{matrix}{m}_{a} \\ {m}_{b}\end{matrix} ] = [ \begin{matrix}M {λ}_{2} \\ M {λ}_{3}\end{matrix} ] \qquad 12 )$$

From equation 12), we obtain mₐ and m_{b}.

$$[ \begin{matrix}{m}_{a} \\ {m}_{b}\end{matrix} ] = {[ \begin{matrix}cos 4 ( {φ}_{a} - {ψ}_{2} ) & cos 4 ( {φ}_{b} - {ψ}_{2} ) \\ cos 6 ( {φ}_{a} - {ψ}_{3} ) & cos 6 ( {φ}_{b} - {ψ}_{3} )\end{matrix} ]}^{- 1} [ \begin{matrix}M {λ}_{2} \\ M {λ}_{3}\end{matrix} ] \qquad 13 )$$

By substituting equation 13) in equation 11), we obtain

$$\begin{matrix}{[ \begin{matrix}sin 4 ( {φ}_{a} - {ψ}_{2} ) & sin 4 ( {φ}_{b} - {ψ}_{2} ) \\ sin 6 ( {φ}_{a} - {ψ}_{3} ) & sin 6 ( {φ}_{b} - {ψ}_{3} )\end{matrix} ] [ \begin{matrix}cos 4 ( {φ}_{a} - {ψ}_{2} ) & cos 4 ( {φ}_{b} - {ψ}_{2} ) \\ cos 6 ( {φ}_{a} - {ψ}_{3} ) & cos 6 ( {φ}_{b} - {ψ}_{3} )\end{matrix} ]}^{- 1} \\ [ \begin{matrix}M {λ}_{2} \\ M {λ}_{3}\end{matrix} ] = 0\end{matrix} \qquad 14 )$$

φₐ and φ_{b} can be obtained from equation 14), and mₐ and m_{b} can be calculated from equation 13). The dual mode equivalent ring model obtained from the above results is an equivalent model that the natural frequencies and the mode shape is the exactly same as the original ring model in n=2 mode and n=3 mode.

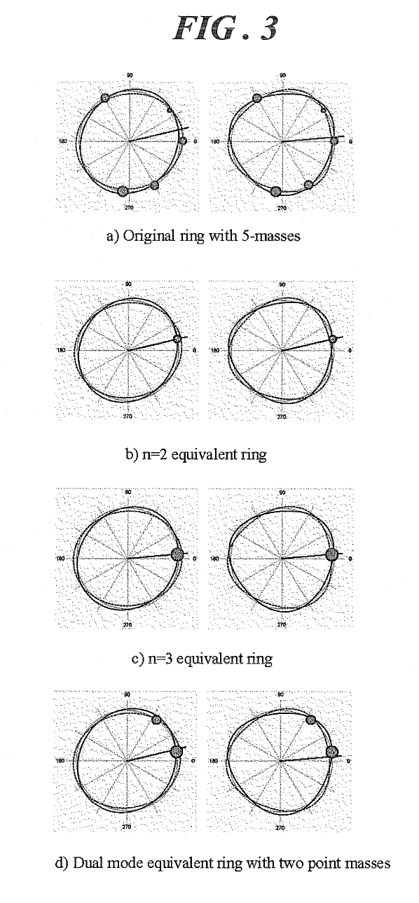

In order to justify the method, we consider an axisymmetric ring structure to represent a real bell, shown in Table 1. This structure is designed such that it has the same first frequency (n=2 mode) as that of the famous Divine Bell of King Seongdeok. For inducing the asymmetry, we add five point masses—mᵢ=[3, 1, 4, 6, 4]kg and Φᵢ=[0, 35, 125, 260, 300]°—to the ring. The natural frequencies and mode shapes of the original asymmetric ring are given in Table 1 and FIG. 3 a), respectively.

TABLE 1
Natural frequency of original ring and equivalent
rings

| | |
|---|---|
| | M = 1702.5 kg, ρ = 8700 kg/m³, |
| Specification of axi- | R = 1.012 m, E = 5.6e10 Pa, |
| symmetric ring | h = 0.203 m, d = 0.15 m |

| Mode parameter | Mode | ω₁ | ω₂ | ψₙ |
|---|---|---|---|---|
| Original ring | n = 2 | 64.57 | 64.64 | 14.49 |
| | n = 3 | 182.25 | 183.05 | 7.57 |
| n = 2 equivalent ring | n = 2 | 64.57 | 64.64 | 14.49 |
| | n = 3 | 182.50 | 182.79 | 14.49 |
| n = 3 equivalent ring | n = 2 | 64.50 | 64.71 | 7.57 |
| | n = 3 | 182.25 | 183.05 | 7.57 |
| Dual mode equivalent | n = 2 | 64.57 | 64.64 | 14.49 |
| ring | n = 3 | 182.25 | 183.05 | 7.57 |

By employing Fox's theoretical solutions, we can acquire an n=2 equivalent model and an n=3 equivalent model that only satisfy the mode condition for each n=2 and n=3 mode from Table 1. The results are as follows.

n=2 equivalent ring model: m_{eq}=[3.3285]kg, φ_{eq}=[14.49]°
n=3 equivalent ring model: m_{eq}=[9.4143]kg, φ_{eq}=[7.57]°

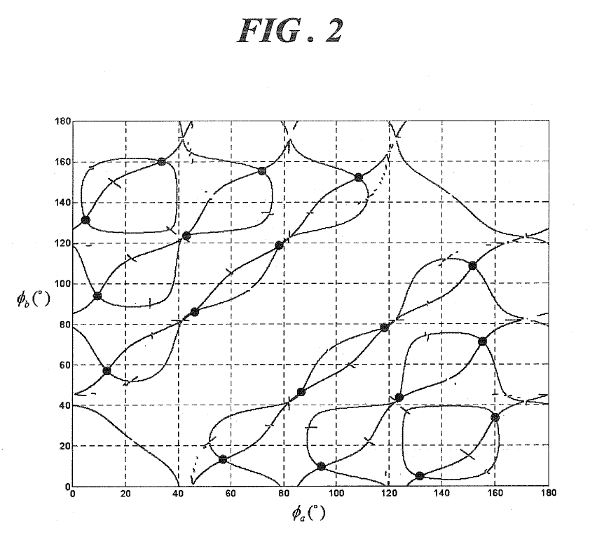

In Table 1, the dual mode equivalent ring model can be acquired by substituting n=2 and n=3 mode data in equation 13) and 14) simultaneously. Using equation 14), the positions of two masses φₐ and φ_{b} that satisfy n=2 and n=3 mode data are located and illustrated as the cross points of the curve in FIG. 2.

The cross points in FIG. 2 become φₐ and φ_{b} and they are symmetric according to the x=y curve. The reason for this is that equation 14) complete when we exchange φₐ and φ_{b} and the order of the two masses has no effect on the asymmetry. Table 2 lists nine solutions of the dual mode equivalent ring model shown in FIG. 2.

TABLE 2
n = 2 and n = 3 equivalent models

| | | | | | | ω_{2L} (Hz) | ω_{2H} (Hz) | ψ₂ (°) | T_{2b} (s) |
|---|---|---|---|---|---|---|---|---|---|
| No. | φₐ (°) | φ_{b} (°) | mₐ (kg) | m_{b} (kg) | M₀ (kg) | ω_{3L} (Hz) | ω_{3H} (Hz) | ψ₃ (°) | T_{3b} (s) |
| 1 | 4.73 | 131.90 | 6.03 | 4.04 | 1692.4 | 64.57 | 64.64 | 14.49 | 14.29 |
| | | | | | | 182.25 | 183.05 | 7.57 | 1.25 |
| 2 | 33.65 | 160.27 | −4.11 | −5.86 | 1712.5 | 64.57 | 64.64 | 14.49 | 14.29 |
| | | | | | | 182.25 | 183.05 | 7.57 | 1.25 |
| 3 | 9.32 | 94.28 | 6.31 | −3.40 | 1699.6 | 64.57 | 64.64 | 14.49 | 14.29 |
| | | | | | | 182.25 | 183.05 | 7.57 | 1.25 |
| 4 | 42.17 | 122.94 | −4.87 | 5.74 | 1701.6 | 64.57 | 64.64 | 14.49 | 14.29 |
| | | | | | | 182.25 | 183.05 | 7.57 | 1.25 |
| 5 | 71.24 | 155.54 | 3.52 | −6.28 | 1705.3 | 64.57 | 64.64 | 14.49 | 14.29 |
| | | | | | | 182.25 | 183.05 | 7.57 | 1.25 |
| 6 | 13.03 | 57.08 | 8.41 | 5.11 | 1689.0 | 64.57 | 64.64 | 14.49 | 14.29 |
| | | | | | | 182.25 | 183.05 | 7.57 | 1.25 |
| 7 | 46.09 | 86.40 | −9.83 | −8.27 | 1720.6 | 64.57 | 64.64 | 14.49 | 14.29 |
| | | | | | | 182.25 | 183.05 | 7.57 | 1.25 |
| 8 | 78.62 | 118.82 | 8.49 | 9.83 | 1684.2 | 64.57 | 64.64 | 14.49 | 14.29 |
| | | | | | | 182.25 | 183.05 | 7.57 | 1.25 |
| 9 | 108.35 | 151.87 | −5.35 | −8.60 | 1716.5 | 64.57 | 64.64 | 14.49 | 14.29 |
| | | | | | | 182.25 | 183.05 | 7.57 | 1.25 |

(T_{2b}: beat period of n = 2 mode, T_{3b}: beat period of n = 3 mode)

Dual mode equivalent ring models of Table 2 satisfy given natural frequencies and the location of the low-mode anti-node of the original ring model. Furthermore, all these models exhibit similar changes in natural frequencies and mode shapes when some imperfection masses are added to or subtracted from them. Therefore, if we use any dual mode equivalent model from among the nine models for tuning the beat characteristics and the location of the nodal line, we will obtain similar results.

3. Dual Mode Tuning Procedure

To identify the beat distribution characteristics, an impulse response under a given striking condition is considered. By the impulse response analysis, a slightly asymmetric ring exhibits a beat in each mode as per the following equation.

$${\ddot{u}}_{n} ( x , θ , t ) = - {e}^{- {ζ}_{na} \frac{{ω}_{nL} + {ω}_{nH}}{2} t} [ \begin{matrix}cos n ( {θ}^{*} - {φ}_{L} ) cos n ( θ - {φ}_{L} ) \\ sin ( {ω}_{nL} t ) + cos n ( θ - {φ}_{H} ) \\ cos n ( θ - {φ}_{H} ) sin ( {ω}_{nH} t )\end{matrix} ] \qquad 15 )$$

(ζₙₐ: average value of damping, ω_{nH}: natural frequency in high mode, ω_{nL}: natural frequency in low mode, θ*: position of striking point, φ_{L}: position of anti-node in low mode, φ_{H}: position of anti-node in high mode)

When the striking point is placed at the center of L, H mode anti-nodes, the L, H modes are equally excited and a clear beat is generated. If n=2 mode, the anti-nodes of L-mode and H-mode exist at intervals of 45 degree each other. If n=3 mode, the anti-nodes are arranged at intervals of 30 degree. It is therefore desirable to modify a Korean bell after casting so that the anti-node in the n=2 mode is located at 22.5 or −22.5 degrees and that in the n=3 mode, at 15 or −15 degrees from the striking point. That is, the striking point will be placed at the center of the two anti-nodes and thus it will generate the vibration of the L, H modes with the same magnitude at the same time. The beat period is also as important a factor as beat clarity. When the beat period is too long, people will not hear the beating sound. A short beat period makes the sound appear like a warble. People naturally experience a sound filled with vitality when the beat period in the n=2 mode is 3 to 4 s, such as the period of human breathing. In accordance with the present disclosure, the original ring can be tuned so that it had a clear beat with an appropriate period. The original ring does not exhibit a very good mode condition for a clear beat because the n=2 mode anti-node is located at 14.49 degree and the n=3 mode is located at 7.57 degree. The n=2 and n=3 low-mode anti-nodes should be shifted to 22.5 degree and 15 degree, respectively, so that a clear beat is obtained. Furthermore, the beat period in the n=2 mode of the original ring model was 14.29 s, which is too long, and that in the n=3 mode was 1.25 s, which is too short. We tuned the original ring model so that its beat period in the n=2 and n=3 modes was 4 and 7 s, respectively, with reference to the beat period of the Divine Bell of King Seongdeok. Similar results are obtained when any dual mode equivalent ring model are used. Here, we use the sixth dual mode equivalent ring model shown in Table 2 (mᵢ=[8.42, 5.11]kg, Φᵢ=[13.03, 57.08]).

Tuning objective: T_{2b}=4 s, T_{3b}=7 s, ψ₂*=22.5 degree, ψ₃*=15.0 degree
(T_{nb}: beat period of n-th mode, ψₙ*: target position of the n-th mode anti-node)

We apply constraints to λ₂ and λ₃ in equation 9) and 10) to satisfy the target beat period in the manner shown below.

$${λ}_{n} = \frac{( {ω}_{nL}^{2} - {ω}_{nH}^{2} ) ( 1 + {α}_{n}^{2} )}{( {ω}_{nL}^{2} + {ω}_{nH}^{2} ) ( 1 - {α}_{n}^{2} )} = \frac{( {ω}_{nL} + {ω}_{nH} ) ( {ω}_{nL} - {ω}_{nH} ) ( 1 + {α}_{n}^{2} )}{( {ω}_{nL}^{2} + {ω}_{nH}^{2} ) ( 1 - {α}_{n}^{2} )} ∝ ( {ω}_{nL} - {ω}_{nH} ) = \frac{1}{{T}_{nb}} \qquad 16 )$$

We use

$$\frac{1}{{k}_{n}} {λ}_{n}$$

instead of λₙ to increase the beat period by kₙ times because λₙ is nearly inversely proportional to T_{nb}. When we add m_{c} and m_{d} to φ_{c} and φ_{d} and develop the dual mode equivalent ring model to satisfy the target beat period and the location of the low-mode anti-node, the following equations are obtained.

mₐ sin 4(φₐ−ψ₂*)+m_{b} sin 4(φ_{b}−ψ₂*)+m_{c} sin 4(φ_{c}−ψ₂*)+m_{d} sin 4(φ_{d}−ψ₂*)=0 17)

$${m}_{a} cos 4 ( {φ}_{a} - {ψ}_{2}^{*} ) + {m}_{b} cos 4 ( {φ}_{b} - {ψ}_{2}^{*} ) + {m}_{c} cos 4 ( {φ}_{c} - {ψ}_{2}^{*} ) + {m}_{d} cos 4 ( {φ}_{d} - {ψ}_{2}^{*} ) = M \frac{1}{{k}_{2}} {λ}_{2} \qquad 18 )$$

mₐ sin 6(φₐ−ψ₃*)+m_{b} sin 6(φ_{b}−ψ₃*)+m_{c} sin 6(φ_{c}−ψ₃*)+m_{d} sin 6(φ_{d}−ψ₃*)=0 19)

$${m}_{a} cos 6 ( {φ}_{a} - {ψ}_{3}^{*} ) + {m}_{b} cos 6 ( {φ}_{b} - {ψ}_{3}^{*} ) + {m}_{c} cos 6 ( {φ}_{c} - {ψ}_{3}^{*} ) + {m}_{d} cos 6 ( {φ}_{d} - {ψ}_{3}^{*} ) = M \frac{1}{{k}_{3}} {λ}_{3} \qquad 20 )$$

Here, mₐ, m_{b}, φₐ, φ_{b}, λ₂, λ₃ provide information on the n=2 and n=3 equivalent ring models, and the values of these parameters are already known. Therefore, by equating 17) to 20) to calculate m_{c}, m_{d}, φ_{c}, φ_{d}, the values of which are not known, we obtain the following equations,

$$\begin{matrix}\begin{matrix}[ \begin{matrix}sin 4 ( {φ}_{c} - {ψ}_{2}^{*} ) & sin 4 ( {φ}_{d} - {ψ}_{2}^{*} ) \\ sin 6 ( {φ}_{d} - {ψ}_{3}^{*} ) & sin 6 ( {φ}_{d} - {ψ}_{3}^{*} )\end{matrix} ] [ \begin{matrix}{m}_{c} \\ {m}_{d}\end{matrix} ] = \\ [ \begin{matrix}- {m}_{a} sin 4 ( {φ}_{a} - {ψ}_{2}^{*} ) - {m}_{b} sin 4 ( {φ}_{b} - {ψ}_{2}^{*} ) \\ - {m}_{a} sin 6 ( {φ}_{a} - {ψ}_{3}^{*} ) - {m}_{b} sin 6 ( {φ}_{b} - {ψ}_{3}^{*} )\end{matrix} ]\end{matrix} & 21 ) \\ \begin{matrix}[ \begin{matrix}cos 4 ( {φ}_{c} - {ψ}_{2}^{*} ) & cos 4 ( {φ}_{d} - {ψ}_{2}^{*} ) \\ cos 6 ( {φ}_{c} - {ψ}_{3}^{*} ) & cos 6 ( {φ}_{d} - {ψ}_{3}^{*} )\end{matrix} ] [ \begin{matrix}{m}_{c} \\ {m}_{d}\end{matrix} ] = \\ [ \begin{matrix}- {m}_{a} cos 4 ( {φ}_{a} - {ψ}_{2}^{*} ) - {m}_{b} cos 4 ( {φ}_{b} - {ψ}_{2}^{*} ) + M \frac{1}{{k}_{2}} {λ}_{2} \\ - {m}_{a} cos 6 ( {φ}_{a} - {ψ}_{3}^{*} ) - {m}_{b} cos 6 ( {φ}_{b} - {ψ}_{3}^{*} ) + M \frac{1}{{k}_{3}} {λ}_{3}\end{matrix} ]\end{matrix} & 22 )\end{matrix}$$

From equations 21) and 22), we obtain equation 23).

$$\begin{matrix}{[ \begin{matrix}cos 4 ( {φ}_{c} - {ψ}_{2}^{*} ) & cos 4 ( {φ}_{d} - {ψ}_{2}^{*} ) \\ cos 6 ( {φ}_{c} - {ψ}_{3}^{*} ) & cos 6 ( {ψ}_{d} - {ψ}_{3}^{*} )\end{matrix} ] [ \begin{matrix}sin 4 ( {φ}_{c} - {ψ}_{2}^{*} ) & sin 4 ( {φ}_{d} - {ψ}_{2}^{*} ) \\ sin 6 ( {φ}_{d} - {ψ}_{3}^{*} ) & sin 6 ( {φ}_{d} - {ψ}_{3}^{*} )\end{matrix} ]}^{- 1} \\ [ \begin{matrix}- {m}_{a} sin 4 ( {φ}_{a} - {ψ}_{2}^{*} ) - {m}_{b} sin 4 ( {φ}_{b} - {ψ}_{2}^{*} ) \\ - {m}_{a} sin 6 ( {φ}_{a} - {ψ}_{3}^{*} ) - {m}_{b} sin ( {φ}_{b} - {ψ}_{3}^{*} )\end{matrix} ] = \\ [ \begin{matrix}- {m}_{a} cos 4 ( {φ}_{a} - {ψ}_{2}^{*} ) - {m}_{b} cos 4 ( {φ}_{b} - {ψ}_{2}^{*} ) + M \frac{1}{{k}_{2}} {λ}^{2} \\ - {m}_{a} cos 6 ( {φ}_{a} - {ψ}_{3}^{*} ) - {m}_{b} cos 6 ( {φ}_{b} - {ψ}_{3}^{*} ) + M \frac{1}{{k}_{3}} {λ}_{3}\end{matrix} ]\end{matrix} \qquad 23 )$$

Here, information on the sixth dual mode equivalent ring model listed in Table 2 is as follows.
mₐ=8.42 kg, m_{b}=5.11 kg, φₐ=13.03°, φ_{b}=57.08°, λ₂=0.002, λ₃4=0.0055, T_{2b}=13.28 s, T_{3b}=1.25 s, ψ₂*=±22.5°, ψ₃*=±15°

If we wish to change the beat period of the original ring model by 4 s in the n=2 mode and by 7 s in the n=3 mode,

$${k}_{2} = \frac{4}{13.28} \text{and} {k}_{3} = \frac{7}{1.25}$$

should be set.

By substituting the above data in equation 23), we obtain

$$\begin{matrix}{[ \begin{matrix}cos 4 ( {φ}_{c} - {ψ}_{2}^{*} ) & cos 4 ( {φ}_{d} - {ψ}_{2}^{*} ) \\ cos 6 ( {φ}_{c} - {ψ}_{3}^{*} ) & cos 6 ( {φ}_{d} - {ψ}_{3}^{*} )\end{matrix} ] [ \begin{matrix}sin 4 ( {φ}_{c} - {ψ}_{2}^{*} ) & sin 4 ( {φ}_{d} - {ψ}_{2}^{*} ) \\ sin 6 ( {φ}_{d} - {ψ}_{3}^{*} ) & sin 6 ( {φ}_{d} - {ψ}_{3}^{*} )\end{matrix} ]}^{- 1} \\ [ \begin{matrix}1.766 \\ 6.600\end{matrix} ] = [ \begin{matrix}8.2302 \\ - 5.0155\end{matrix} ]\end{matrix} \qquad 24 )$$

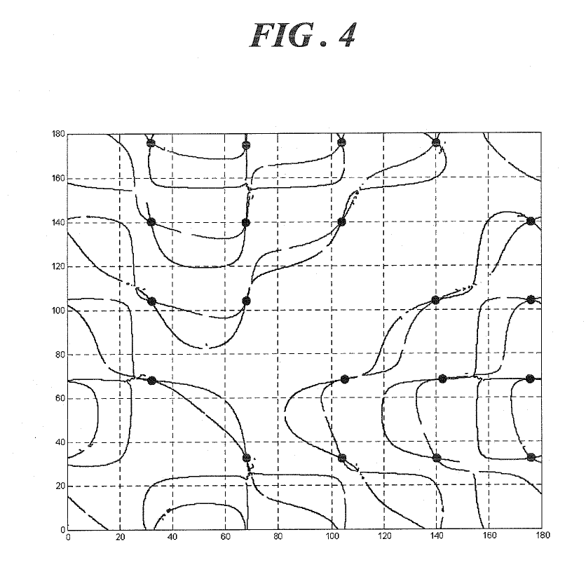

From equation 24), we can generate FIG. 4, and the cross points in the two curves in FIG. 4 become φ_{c} and φ_{d}, which are the attachment positions of the two masses. If we apply φ_{c} and φ_{d} to equation 22), we can calculate m_{c} and m_{d}, which are the magnitudes of the two masses.

In FIG. 4 we have twenty solutions that are symmetric according to the x=y curve. Based on symmetry, only ten solutions from these are selected and the results are listed in Table 3.

TABLE 3
Tuning results in beat and location of low mode anti-node

| Specification of | | M = 1702.5 kg, ρ = 8700 kg/m³, R = 1.012 m, | | | | |
|---|---|---|---|---|---|---|
| axisymmetric ring | | E = 5.6e10 Pa, h = 0.203 m, d = 0.15 m | | | | |
| | Magnitude and position of | | | | Beat | |
| num | 3^{rd} and 4^{th} masses | Mode | ω_{nL} (Hz) | ω_{nH} (Hz) | period(s) | ψₙ (°) |
| 1 | m = [12.53, 6.23] kg | n = 2 | 64.133 | 64.379 | 4.07 | −22.5 |
| | Φ = [31.97, 176.14]° | n = 3 | 181.582 | 181.726 | 6.93 | −15.0 |
| 2 | m = [8.71, −3.81] kg | n = 2 | 64.389 | 64.638 | 4.02 | 22.49 |
| | Φ = [31.92, 140.12]° | n = 3 | 182.311 | 182.453 | 7.0 | 14.97 |
| 3 | m = [−7.74, −1.58] kg | n = 2 | 64.658 | 64.910 | 3.97 | 22.49 |
| | Φ = [67.98, 175.46]° | n = 3 | 183.075 | 183.219 | 6.94 | −15.0 |
| 4 | m = [6.37, 3.81] kg | n = 2 | 64.290 | 64.538 | 4.04 | 22.5 |
| | Φ = [31.85, 104.11]° | n = 3 | 182.031 | 182.172 | 7.06 | 15.0 |
| 5 | m = [−8.72, 1.58] kg | n = 2 | 64.616 | 64.868 | 3.97 | 22.50 |
| | Φ = [67.92, 139.46]° | n = 3 | 182.957 | 183.100 | 6.96 | 15.14 |
| 6 | m = [7.74, −6.38] kg | n = 2 | 64.456 | 64.705 | 4.00 | 22.5 |
| | Φ = [103.96, 175.85]° | n = 3 | 182.5 | 182.643 | 7.01 | 15.14 |
| 7 | m = [2.54, −6.17] kg | n = 2 | 64.55 | 64.801 | 3.99 | 22.47 |
| | Φ = [31.48, 68.08]° | n = 3 | 182.768 | 182.911 | 6.98 | 15.03 |
| 8 | m = [−10.30, −2.56] kg | n = 2 | 64.725 | 64.978 | 3.95 | 22.49 |
| | Φ = [67.85, 103.46]° | n = 3 | 183.266 | 183.411 | 6.92 | 15.01 |
| 9 | m = [14.13, 10.31] kg | n = 2 | 64.025 | 64.270 | 4.09 | 22.47 |
| | Φ = [103.89, 139.84]° | n = 3 | 181.278 | 181.418 | 7.15 | 15.26 |
| 10 | m = [−12.53, −4.20] kg | n = 2 | 64.992 | 65.248 | 3.91 | 22.60 |
| | Φ = [139.96, 175.94]° | n = 3 | 184.023 | 184.169 | 6.82 | 15.66 |

We can verify that the location of the n=2 mode anti-node has shifted to ψ₂=±22.5° and that of the n=3 mode has shifted to ψ₃=±15° in all the ten tuning results. The beat period in the n=2 mode has changed to about 4 s and that in the n=3 mode has changed to about 7 s; these values are in agreement with our target tuning objective. In other words, the similar tuning results are obtained even if any dual mode equivalent ring model is used for tuning.

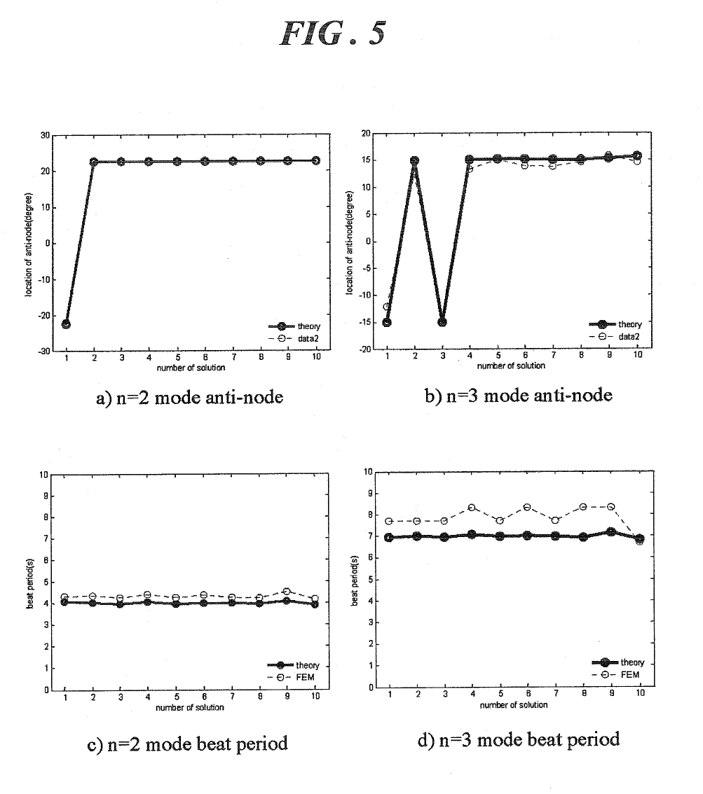

FIG. 5 shows the comparison of the theoretical results and the FEA results after tuning. In FIG. 5 a) and b), the locations of the low-mode anti-node in both the methods are coincident for the ten dual mode equivalent ring models. In FIG. 5 a), the n=2 low-mode anti-node in the first model is located at −22.5 degree, which is different from that in the other models, and it does not influence beat clarity. A similar behavior is observed in the case of the n=3 mode in FIG. 5 b). In FIG. 5 c) and d), the theoretical beat period is slightly greater than that obtained from the FEA because of the initial error due to the thickness effect. However, the beat periods in all the ten models are very similar and this justifies the theoretical analysis. In conclusion, an equivalent model of an asymmetric ring can be constructed from given n=2 and n=3 mode data and the beat characteristics can be tuned by calculating the magnitude and position of additional masses.

In reality, however, it is a more frequent practice to introduce cuts in the structure to modify it rather than add masses. The cut simultaneously diminishes the mass and stiffness, and it is known that the stiffness reduction effect is considerably stronger than the mass reduction effect. Since the stiffness effect is much stronger than the mass effect, the anti-node of the L-mode passes the location of the cut. These phenomena were verified by comparison with the FEA results, which were obtained for a real Korean bell structure. It is very difficult to compose a theoretical equivalent model that reflects the exact cut effect, an equivalent model using imperfection masses could serve as a substitute. However, since the location of the additional equivalent mass is the L-mode anti-node, the cut generates the same effect as the addition of mass in the last analysis. Therefore, we can apply the methods of the present disclosure by regarding the cut as the imperfection mass addition. If we can determine the relationship between the cut effect and the mass effect from measurement or by FEA, we can improve the usefulness of the suggested tuning method in the present disclosure that employs imperfection masses.

In accordance with the above-mentioned methods, optimal beat tuning is achieved by adding or removing masses on necessary locations to obtain the required beat properties in the beating vibration. The results obtained from the present disclosure are compared with those obtained from finite element analysis (FEA) and the validity of the proposed method is verified. The proposed methods can be effectively used to predict the mode pair and to control the beat property in a slightly asymmetric ring structure like a bell.

While the invention has been shown and described with respect to the embodiments of the present invention, it will be understood by those skilled in the art that various changes and modifications may be made without departing from the spirit and scope of the invention as defined in the following claims.

What is claimed is:

1. A method of beat tuning in a slightly asymmetric ring structure comprising the steps of:
establishing an original ring model which simplifies said ring structure;
establishing an equivalent imperfection mass model which is equivalent to said original ring model and has at least one or more point masses on an asymmetric ring;
determining magnitudes and positions of the point masses in said equivalent imperfection mass model based on mode data of said original ring model; and
determining magnitudes and positions of masses which should be added to or removed from said equivalent imperfection mass model in order to obtain desired beat properties.

2. The method of claim 1, wherein said beat tuning is tuned for n=2 mode if the mode data of said original ring model are given by the natural frequencies and the location of anti-node of n=2 mode pair.

3. The method of claim 1, wherein said beat tuning is tuned for n=3 mode if the mode data of said original ring model are given by the natural frequencies and the location of anti-node of n=3 mode pair.

4. The method of claim 1, wherein said beat tuning is simultaneously tuned for n=2 mode and n=3 mode if the mode data of said original ring model are given by the natural frequencies and the locations of anti-node of both n=2 and n=3 mode pairs.

5. The method of claim 4, wherein the magnitudes (m_{c}, m_{d}) and the positions (φ_{c}, φ_{d}) of the masses which should be added or removed in order to simultaneously tune said two modes are determined by using the following equation:
$$\begin{matrix}{[ \begin{matrix}cos 4 ( {φ}_{c} - {ψ}_{2}^{*} ) & cos 4 ( {φ}_{d} - {ψ}_{2}^{*} ) \\ cos 6 ( {φ}_{c} - {ψ}_{3}^{*} ) & cos 6 ( {φ}_{d} - {ψ}_{3}^{*} )\end{matrix} ] [ \begin{matrix}sin 4 ( {φ}_{c} - {ψ}_{2}^{*} ) & sin 4 ( {φ}_{d} - {ψ}_{2}^{*} ) \\ sin 6 ( {φ}_{d} - {ψ}_{3}^{*} ) & sin 6 ( {φ}_{d} - {ψ}_{3}^{*} )\end{matrix} ]}^{- 1} \\ [ \begin{matrix}- {m}_{a} sin 4 ( {φ}_{a} - {ψ}_{2}^{*} ) - {m}_{b} sin 4 ( {φ}_{b} - {ψ}_{2}^{*} ) \\ - {m}_{a} sin 6 ( {φ}_{a} - {ψ}_{3}^{*} ) - {m}_{b} sin 6 ( {φ}_{b} - {ψ}_{3}^{*} )\end{matrix} ] = \\ [ \begin{matrix}- {m}_{a} cos 4 ( {φ}_{a} - {ψ}_{2}^{*} ) - {m}_{b} cos 4 ( {φ}_{b} - {ψ}_{2}^{*} ) + M \frac{1}{{k}_{2}} {λ}_{2} \\ - {m}_{a} cos 6 ( {φ}_{a} - {ψ}_{3}^{*} ) - {m}_{b} cos 6 ( {φ}_{b} - {ψ}_{3}^{*} ) + M \frac{1}{{k}_{3}} {λ}_{3}\end{matrix} ]\end{matrix} \qquad$$

6. The method of claim 1, wherein said beat tuning is carried out in consideration of a mass effect and a stiffness effect.
